(19) United States
(12) Patent Application Publication
(10) Pub. No.: US 2026/0175851 A1
(43) Pub. Date: Jun. 25, 2026

(54) REMOTE-CONTROLLED RESET

(71) Applicant: Infineon Technologies AG, Neubiberg (DE)

(72) Inventors: Timo Dittfeld, Muenchen (DE); Benno Koeppl, Markt Indersdorf (DE)

(21) Appl. No.: 19/418,785

(22) Filed: Dec. 12, 2025

(30) Foreign Application Priority Data
Dec. 19, 2024 (DE) 102024138950.8

(51) Int. Cl. B60W 50/02; H04L 41/04

(52) U.S. Cl. CPC B60W 50/0225; H04L 41/04

(57) ABSTRACT

An electronic control unit (114) is presented. The electronic control unit (114) comprises an electronic device (118), an application controller (128) and a safety node (134). The application controller (128) is configured for controlling the electronic device (118). The safety node (134) is configured for monitoring input signals sent from a supervising controller (112) to the electronic control unit (114). The safety node (134) is further configured for identifying a failure signal from the input signals. The safety node (134) is further configured for triggering a reset of the application controller (128) when identifying the failure signal. Further, a method for triggering a reset and a control system (110) are presented.

### TECHNICAL FIELD

The present disclosure relates to an electronic control unit, a method for triggering a reset, a control system and a use thereof.

### BACKGROUND

Control systems, e.g. for automotive applications, nowadays typically comprise a plurality of distributed controllers. As an example, in an automotive application, a plurality of different controllers may be distributed within a vehicle. The controllers may control at least partially different applications, e.g. different motors in the vehicle. The controllers may further have different hierarchies. As an example, a vehicle may be controlled by a supervising controller, such as a central controller or by several zone controllers, which may again control different application controllers for different applications in the vehicle. For safety relevant applications, the application controllers may each have local monitoring functions for complying with a corresponding safety integrity level. This typically increases complexity and thus also cost.

### SUMMARY

In a first aspect, an electronic control unit is presented. The electronic control unit comprises an electronic device, an application controller and a safety node. The application controller is configured for controlling the electronic device. The safety node is configured for monitoring input signals sent from a supervising controller to the electronic control unit. The safety node is further configured for identifying a failure signal from the input signals. The safety node is further configured for triggering a reset of the application controller when identifying the failure signal.

In a further aspect, a method for triggering a reset is presented. The method comprises:
a) receiving input signals from a supervising controller at an electronic control unit;
b) monitoring e input signals by using a safety node of the electronic control unit; and
c) triggering a reset of an application controller of the electronic control unit when identifying a failure signal from the input signals.

In a further aspect, a control system is presented. The control system comprises a supervising controller. The supervising controller is configured for controlling an electronic control unit. The control system further comprises an electronic control unit. The electronic control unit comprises an electronic device, an application controller and a safety node. The application controller is configured for controlling the electronic device. The safety node is configured for monitoring input signals sent from a supervising controller to the electronic control unit. The safety node is further configured for identifying a failure signal from the input signals. The safety node is further configured for triggering a reset of the application controller when identifying the failure signal.

In a further aspect, a use for an automotive application of the electronic control unit, of the method for triggering a reset and/or of the control system is presented.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 to 4 illustrate examples of a control system according to the present disclosure; and

FIG. 5 illustrates a flow chart of an example of a method for triggering a reset according to the present disclosure.

### DETAILED DESCRIPTION

The examples described herein provide considerable advantages. The control system according to the present disclosure can facilitate a centralization and harmonization of safety monitoring and failure event handling, e.g. within a vehicle. Specifically, an operation of different application controllers may be monitored by a supervising controller. The supervising controller may then comply with a higher safety integrity level. On the other hand, the application controllers may only comply with a lower safety integrity level reflecting in lower complexity and eventually in lower cost. Nevertheless, by using a designated safety node, overall safety may still be guaranteed.

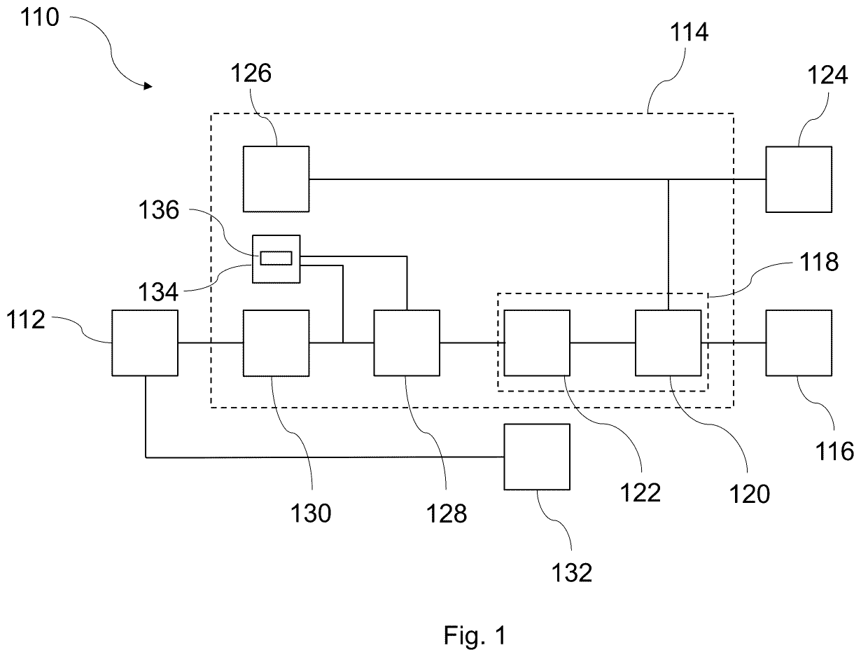

FIG. 1 schematically illustrates an example of a control system 110. The control system 110 comprises a supervising controller 112. The supervising controller 112 is configured for controlling an electronic control unit 114. The electronic control unit 114 may be an embedded system, specifically in an automotive application, e.g. for motor control. The supervising controller 112 may be configured for controlling further not shown electronic control units and may itself also be an electronic control unit or at least a part thereof. Thus, the supervising controller 112 may be a supervising electronic control unit or at least a part thereof. Specifically, the supervising controller 112 may be zone controller or a central controller. The control system 110 may specifically be a control system of a vehicle. In this context, a central controller may be configured for at least indirectly controlling the entire vehicle, e.g. by using subordinate controllers. A zone controller may be configured for controlling spatial or functional zones of the vehicle. The supervising controller 112 may be or may comprise a microcontroller, specifically a main microcontroller of the control system 110. The supervising controller 112 may specifically comprise a central processing unit. The supervising controller 112 may be configured for monitoring further components of the control system 110, such as the electronic control unit 114 or at least a part thereof. Thus, the supervising controller 112 may be configured for identifying a failure event within the control system 110.

The electronic control unit 114 may be configured for controlling a load 116. The load 116 may be or may comprise a motor or an actuator for instance. Other applications may however also be feasible. The load 116 may define the application of the electronic control unit 114. The electronic control unit 114 comprises an electronic device 118. The electronic device 118 may be configured for controlling and specifically for switching the load 116. Thus, the electronic device 118 may specifically be or may comprise a switch 120. The switch 120 may be configured for switching the load 116 on and off. The switch 120 may specifically be or may comprise a transistor, such as a field effect transistor. The electronic device 118 may further comprise a driver 122. The driver 122 may be configured for driving the switch 120. As an example, the switch 120 may be a field effect transistor and the driver 122 may be a gate driver configured for controlling a gate of the field effect transistor. In an ON state, the field effect transistor may then for instance supply the load 116 with power from a power supply 124. The electronic control unit 114 may further comprise a power adapter 126. The power adapter 126 may be configured for managing a power supply including conversion and monitoring. As an example, the power supply 124 may be or may comprise a battery. Thus, the power adapter 126 may for instance be configured for monitoring the battery, e.g. with respect to a battery lifetime, and/or for converting a battery voltage to a voltage applicable to the electronic control unit 114 and/or to the load 116. Specifically, the power adapter 126 may be a power management integrated circuit.

The electronic control unit 114 further comprises an application controller 128. The application controller 128 is configured for controlling the electronic device 118. Thus, the application controller 128 may at least indirectly be configured for controlling the load 116. The application controller 128 may be or may comprise a microcontroller. The application controller 128 may be configured for performing the main processing functions of the electronic control unit 114. The application controller 128 may specifically be configured for receiving and processing input signals from the supervising controller 112, such as for controlling the electronic device 118 and thus at least indirectly the load 116. Further, the application controller 128 may be configured for sending output signals to the supervising controller 112, such as output signals indicating an operation status of the application controller 128. The signals, be it input signals or output signals, may be analog signals or digital signals. The digital signals may also be referred to as messages. As an example, a signal may comprise a data frame. The electronic control unit 114 may further comprise a transceiver 130, such as for communication between the application controller 128 and the supervising controller 112. Thus, the signals may be passed on via the transceiver 130.

Summarizing, the supervising controller 112 may be updated regularly on an operation of the application controller 128. The supervising controller 112 may thus be configured for detecting a failure of the application controller 128. Further, the supervising controller 112 may receive additional signals from other components. As an example, the supervising controller 112 may receive sensor signals. Thus, the control system 110 may comprise a sensor 132. The sensor 132 may be configured for observing the control system 110 or at least a part thereof. Specifically, the sensor 132 may be configured for observing the electronic control unit 114 and/or the load 116. The supervising controller 112 may be configured for evaluating the signals received from further components. Based on this, the supervising controller 112 may be configured for identifying a failure, such as a failure of the electronic control unit 114 or at least a part thereof or a failure of the load 116. In case of such a failure event, the supervising controller 112 may be configured for sending a failure signal to the electronic control unit 114. Specifically, the supervising controller 112 may be configured for identifying a failure of the application controller 128 and for sending a failure signal to the electronic control unit 114. Thus, the failure signal may relate to a failure of the application controller 128. Other options may however also be feasible, such as failure of another component of the electronic control unit 114 or a failure of the load 116, e.g. detected by using the sensor 132.

The electronic control unit 114 further comprises a safety node 134. The safety node 134 is configured for monitoring input signals sent from the supervising controller 112 to the electronic control unit 114. Thus, the safety node 134 may be configured for observing input signals from the supervising controller 112. The safety node 134 may be configured for monitoring signal traffic between the supervising controller 112 and the electronic control unit 114, specifically between the supervising controller 112 and the application controller 128. The safety node 134 is further configured for identifying a failure signal from the input signals. For this purpose, the safety node may comprise a signal filter 136. The signal filter 136 may for instance be a digital filter. The signal filter 136 may be configured for comparing the input signals with a predetermined fixed signal for identifying the failure signal. The fixed signal may for instance be predetermined in a communication protocol used within the control system 110. The safety node 134 is further configured for triggering a reset of the application controller 128 when identifying the failure signal. Thus, the safety node 134 may specifically be configured for triggering a reset of the application controller 128 when an input signal matches the predetermined fixed signal. Further, the safety node 134 may be configured for triggering the reset of the application controller 128 by sending a reset signal to the application controller 128 when identifying the failure signal.

The safety node 134 may comply with a sufficiently high safety integrity level, SIL, or specifically with a sufficiently high automotive integrity level (ASIL) for the respective application of the electronic control unit 114. In other words, the safety node 134 may comply with a SIL of an overall safety requirement of the electronic control unit 114 or specifically with an ASIL of an overall safety requirement of the electronic control unit 114. The IEC 61508 standard defines four SILs for functional safety, with SIL4 being the most dependable, followed by SIL3, then SIL2 and lastly SIL1 being the least dependable. Accordingly, the ISO 26262 standard defines four ASILs for the field of automotive with ASIL D having the highest safety requirements, followed by ASIL C, then ASIL B and lastly ASIL A having the lowest safety requirements. As an example, ASIL D refers to likely potential for severely life-threatening or fatal injury in case of a failure event, e.g. a loss of braking on all wheels of a car, and thus requires the highest safety level.

The safety node 134 may specifically comply with SIL3 or even with SIL4. More specifically, in an automotive application, the safety node 134 may comply with ASIL D. Accordingly, the signal filter 136 may comply with a SIL of an overall safety requirement of the electronic control unit, specifically with SIL3 or SIL4, more specifically with ASIL D. On the other hand, the application controller 128 may then only comply with a lower SIL or ASIL, respectively. Thus, a less complex and less expensive application controller 128 may be used within the electronic control unit 114. Accordingly, the application controller 128 may comply with a SIL lower than a SIL of an overall safety requirement of the electronic control unit 114 or with an ASIL lower than an ASIL of an overall safety requirement of the electronic control unit 114. Specifically, the application controller may only comply with a SIL lower than SIL4 or even SIL3 or an ASIL lower than ASIL D. It shall be noted that in principle the safety node 134 may nevertheless also be incorporated within the application controller 128. In other words, the safety node 134 may also be a part of the application controller 128. In such case, the safety node 134 may be a separated unit within the application controller 128. Thus, the safety node 134 may be separated from further components of the application controller 134 which may only comply with a lower SIL or ASIL.

As already indicated, with this approach, safety monitoring and failure event handling may be less focused on the application controller 128 and instead more focused on the supervising controller 112. As said, the supervising controller 112 may be configured for monitoring an operation of the application controller 128 and specifically for identifying a failure of the application controller 128. The supervising controller 112 may be configured for acting as a remote watchdog for the electronic control unit 114 and specifically for the application controller 128. Thus, the supervising controller 112 may be configured for remotely controlling the reset of the application controller 128, specifically by using the safety node 134. As a result, the supervising controller 112 may also comply with a SIL of an overall safety requirement of the control system 110 or specifically with an ASIL of an overall safety requirement of the control system 110. The supervising controller 112 may specifically comply with SIL3 or SIL4. More specifically, in an automotive application, the application controller 112 may comply with ASIL D.

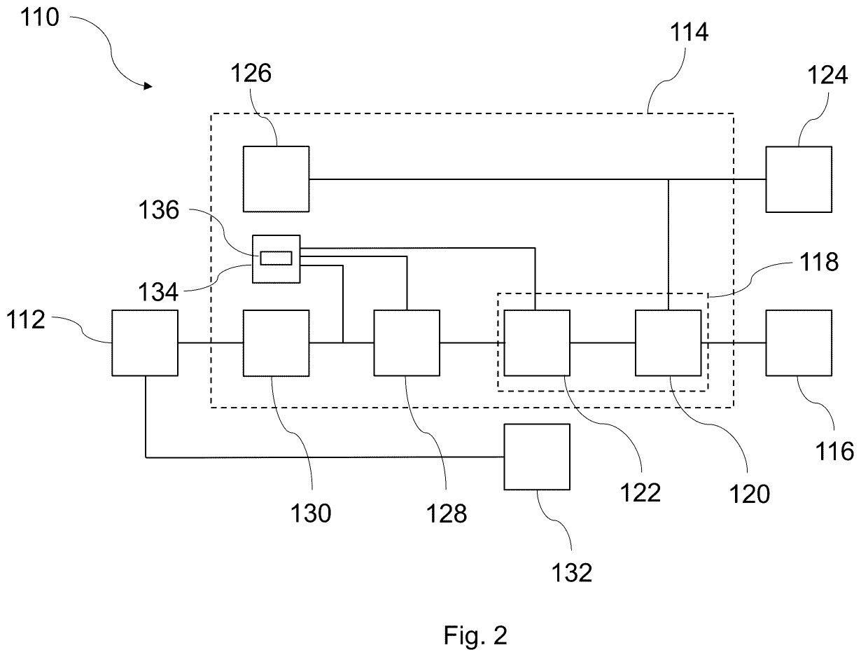

FIG. 2 schematically illustrates a further example of the control system 110. FIG. 2 corresponds to FIG. 1 at least to a large extent. Thus, for the description of FIG. 2, reference may also be made to the description of FIG. 1 at least to a large extent. As specifically indicated in FIG. 2, the safety node 134 may further be configured for triggering a safe state when identifying a failure signal, such as by sending a safe state signal to the electronic device 118. The safe state may specifically be a safe state of the load 116. As an example, the safe state may be an OFF state of a motor. Additionally or alternatively, the safe state may be a safe state of the electronic control unit 114 or at least of a part thereof or even of the entire control system 110. Generally, the safe state may comprise at least one of an OFF state and an ON state. In principle, the safe state may also comprise a dynamic change between the OFF state and the ON state, such as for instance in a traction converter. Thus, specifically in case of a failure of the application controller 128, the application controller 128 may not only be remotely reset, but the application controller 128 may also be bypassed by using the safety node 136, such as for putting the load 116 in a safe state.

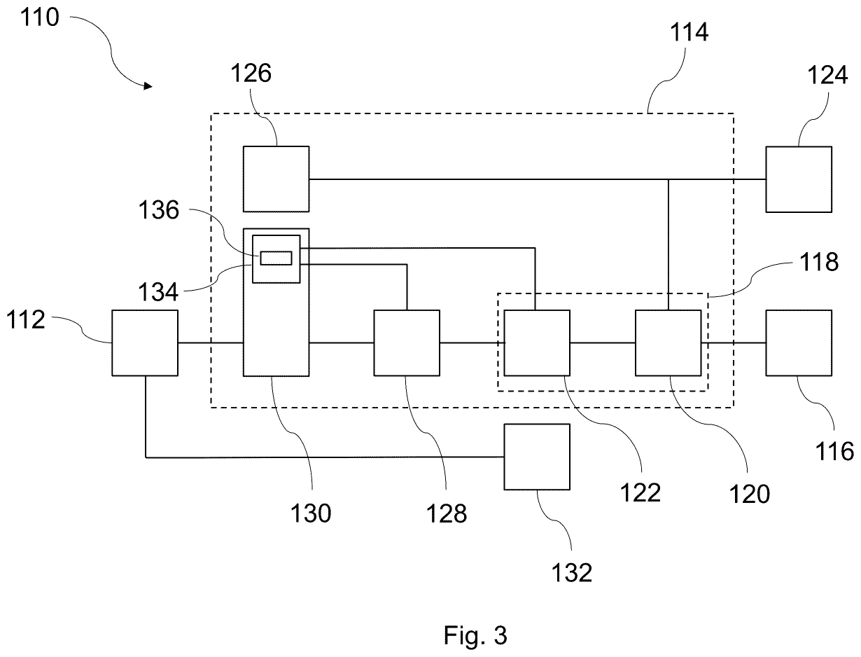

FIG. 3 schematically illustrates a further example of the control system 110. FIG. 3 corresponds to the previous figures at least to a large extent. Thus, for the description of FIG. 3, reference may also be made to the description of the previous figures at least to a large extent. As said, the control system 110 may specifically comprise the transceiver 130, such as for communication between the supervising controller 112 and the application controller 128. As further said, the safety node 134 may be configured for monitoring the communication between the supervising controller 112 and the application controller 128. Thus, as specifically indicated in FIG. 3, the safety node 134 may also be incorporated into the transceiver 130. In other words, the safety node 134 may be a part of the transceiver 130 or the transceiver 130 may comprise the safety node 134. As a result, the safety node 134 may be configured for directly monitoring the input signals from the supervising controller 112 for identifying a failure signal.

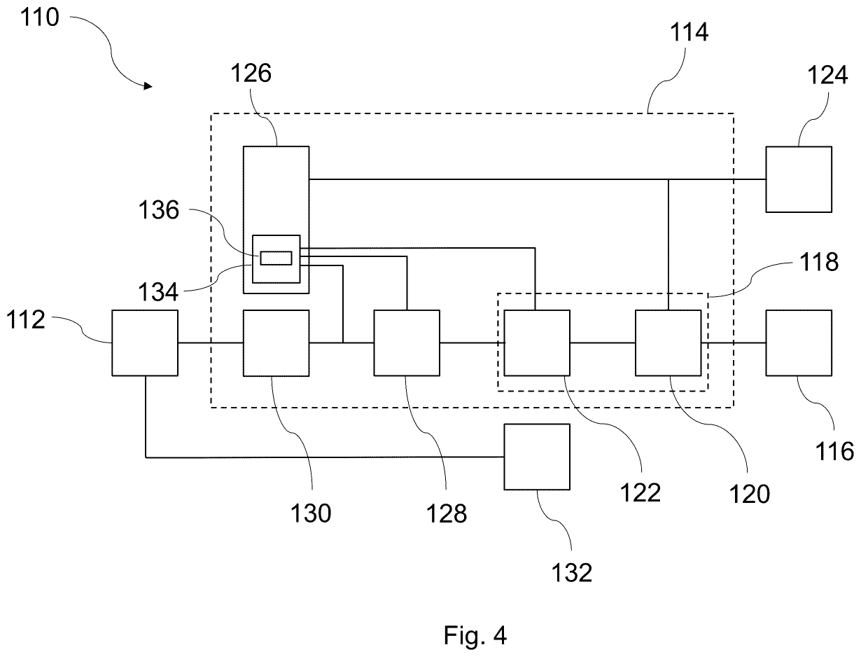

FIG. 4 schematically illustrates a further example of the control system 110. FIG. 4 corresponds to the previous figures at least to a large extent. Thus, for the description of FIG. 4, reference may also be made to the description of the previous figures at least to a large extent. As said, the control system 110 may specifically also comprise the power adapter 126. As FIG. 4 specifically indicates, the safety node 134 may also be a part of the power adapter 126 or, in other words, the power adapter 126 may comprise the safety node 134. Apart from the example illustrated in FIG. 3 showing the safety node 134 as a part of the transceiver 130 and the example illustrated FIG. 4 showing the safety node 134 as a part of the power adapter 126, other options may of course also be feasible. As already indicated, the safety node 134 may be an individual component within the electronic control unit 114 or a separate unit within the application controller 128 or the safety node 134 may of course also be a part of another component of the electronic control unit 114.

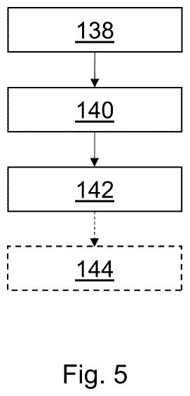

FIG. 5 illustrates a flow chart of an example of a method for triggering a reset. The method comprises the following method steps. The presented method steps may be performed in the indicated order. It shall be noted, however, that a different order may also be possible. The method may comprise further method steps which are not listed. Further, one or more of the method steps may be performed once or repeatedly. Further, two or more of the method steps may be performed simultaneously or in a timely overlapping fashion.
a) (denoted by reference numeral 138) receiving input signals from a supervising controller 112 at an electronic control 114;
b) (denoted by reference numeral 140) monitoring the input signals by using a safety node 134 of the electronic control unit 114; and
c) (denoted by reference numeral 142) triggering a reset of an application controller 128 of the electronic control unit 114 when identifying a failure signal from the input signals; and optionally
d) (denoted by reference numeral 144) triggering a safe state when identifying a failure signal from the input signals.

Specifically, step b) may comprise comparing the input signals with a predetermined fixed signal. Step c) may then comprise triggering the reset of the application controller 128 when an input signal matches the predetermined fixed signal. Step c) may further comprise sending a reset signal to the application controller 128. Accordingly, step d) may comprise sending a safe state signal to the electronic device 118.

The control system 110, the electronic control unit 114 and/or the method for triggering a reset may specifically be used in an automotive application, such as for controlling a load 116 in a vehicle, e.g. a motor. However, other uses may of course also be conceivable.

In addition to the above described examples, the following examples are disclosed herein:

Example 1: An electronic control unit comprising:
an electronic device;
an application controller configured for controlling the electronic device; and
a safety node configured for:
   monitoring input signals sent from a supervising controller to the electronic control unit;
   identifying a failure signal from the input signals; and
   triggering a reset of the application controller when identifying the failure signal.

Example 2: The electronic control unit according to the preceding Example, wherein the failure signal relates to a failure of the application controller.

Example 3: The electronic control unit according to any one of the preceding Examples, wherein the application controller complies with a safety integrity level, SIL, lower than a SIL of an overall safety requirement of the electronic control unit, specifically with a SIL lower than SIL4, more specifically with an automotive safety integrity level, ASIL, lower than ASIL D.

Example 4: The electronic control unit according to any one of the preceding Examples, wherein the safety node complies with a SIL of an overall safety requirement of the electronic control unit, specifically with SIL4, more specifically with ASIL D.

Example 5: The electronic control unit according to any one of the preceding Examples, wherein the safety node comprises a signal filter configured for comparing the input signals with a predetermined fixed signal for identifying the failure signal.

Example 6: The electronic control unit according to the preceding Example, wherein the safety node is configured for triggering a reset of the application controller when an input signal matches the predetermined fixed signal.

Example 7: The electronic control unit according to any one of the two preceding Examples, wherein the signal filter complies with a SIL of an overall safety requirement of the electronic control unit, specifically with SIL4, more specifically with ASIL D.

Example 8: The electronic control unit according to any one of the three preceding Examples, wherein the signal filter is a digital signal filter.

Example 9: The electronic control unit according to any one of the preceding Examples, wherein the safety node is configured for triggering the reset of the application controller by sending a reset signal to the application controller when identifying the failure signal.

Example 10: The electronic control unit according to any one of the preceding Examples, wherein the safety node is further configured for triggering a safe state when identifying the failure signal.

Example 11: The electronic control unit according to the preceding Example, wherein the safety node is configured for triggering the safe state by sending a safe state signal to the electronic device when identifying the failure signal.

Example 12: The electronic control unit according to any one of the two preceding Examples, wherein the safe state is a safe state of a load controlled by the electronic control unit, specifically by the electronic device.

Example 13: The electronic control unit according to any one of the preceding Examples, wherein the electronic device comprises at least one of a switch and a driver.

Example 14: The electronic control unit according to any one of the preceding Examples, wherein the safety node is configured for monitoring a communication between the supervising controller and the application controller.

Example 15: The electronic control unit according to any one of the preceding Examples, further comprising a transceiver for communication with the supervising controller, wherein the safety node is a part of the transceiver.

Example 16: The electronic control unit according to any one of the preceding Examples, further comprising a power adapter, wherein the safety node is a part of the power adapter.

Example 17: The electronic control unit according to the preceding Example, wherein the power adapter is a power management integrated circuit.

Example 18: The electronic control unit according to any one of the preceding Examples, wherein the safety node is a part of the application controller.

Example 19: The electronic control unit according to the preceding Example, wherein the safety node is a separated unit within the application controller.

Example 20: A method for triggering a reset, the method comprising:
a) receiving input signals from a supervising controller at an electronic control unit;
b) monitoring the input signals by using a safety node of the electronic control unit; and
c) triggering a reset of an application controller of the electronic control unit when identifying a failure signal from the input signals.

Example 21: The method according to the preceding Example, wherein the electronic control unit is an electronic control unit according to any one of the preceding Examples referring to an electronic control unit.

Example 22: The method according to any one of the preceding method Examples, wherein step b) comprises comparing the input signals with a predetermined fixed signal.

Example 23: The method according to the preceding Example, wherein step c) comprises triggering the reset of the application controller when an input signal matches the predetermined fixed signal.

Example 24: The method according to any one of the preceding method Examples, wherein step c) comprises sending a reset signal to the application controller.

Example 25: The method according to any one of the preceding method Examples, further comprising:
d) triggering a safe state when identifying a failure signal from the input signals.

Example 26: The method according to the preceding Example, wherein step d) comprises sending a safe state signal to the electronic device.

Example 27: A control system comprising:
a supervising controller configured for controlling an electronic control unit; and
an electronic control unit comprising:
   an electronic device;
   an application controller configured for controlling the electronic device; and
   a safety node configured for:
      monitoring input signals sent from the supervising controller to the electronic control unit;
      identifying a failure signal from the input signals; and
      triggering a reset of the application controller when identifying the failure signal.

Example 28: The control system according to the preceding Example, wherein the electronic control unit is an electronic control unit according to any one of the preceding Examples referring to an electronic control unit.

Example 29: The control system according to any one of the preceding Examples referring to a control system, wherein the supervising controller is configured for monitoring an operation of the application controller, specifically for identifying a failure of the application controller.

Example 30: The control system according to any one of the preceding Examples referring to a control system, wherein the supervising controller complies with a SIL of a safety requirement of the control system, specifically with SIL4, more specifically with ASIL D.

Example 31: The control system according to any one of the preceding Examples referring to a control system, wherein the supervising controller is a central controller or at least a zone controller.

Example 32: A use for an automotive application of at least one of the electronic control unit according to any one of the preceding Examples referring to an electronic control unit, a method for triggering a reset according to any one of the preceding method Examples and a control system according to any one of the preceding Examples referring to a control system.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

It should be noted that the methods and devices including its preferred embodiments as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the disclosure and are included within its spirit and scope. Furthermore, all examples and embodiments outlined in the present document are principally intended expressly to be only for explanatory purposes to help the reader in understanding the principles of the proposed methods and systems. Furthermore, all statements herein providing principles, aspects, and embodiments of the disclosure, as well as specific examples thereof, are intended to encompass equivalents thereof.

1: An electronic control unit comprising:
an electronic device;
an application controller configured to control the electronic device; and
a safety node configured to:
monitor input signals sent from a supervising controller to the electronic control unit;
identify a failure signal from the input signals; and
trigger a reset of the application controller in response to identifying the failure signal.

2: The electronic control unit according to claim 1, wherein the failure signal relates to a failure of the application controller.

3: The electronic control unit according to claim 1, wherein the application controller complies with a safety integrity level (SIL) that is lower than a SIL of an overall safety requirement of the electronic control unit.

4: The electronic control unit according to claim 3, wherein the safety node complies with the SIL of the overall safety requirement of the electronic control unit.

5: The electronic control unit according to claim 1, wherein the safety node comprises a signal filter configured to compare the input signals with a predetermined fixed signal to identify the failure signal.

6: The electronic control unit according to claim 1, wherein the safety node is configured to trigger the reset of the application controller by sending a reset signal to the application controller in response to identifying the failure signal.

7: The electronic control unit according to claim 1, wherein the safety node is further configured to trigger a safe state in response to identifying the failure signal.

8: The electronic control unit according to claim 7, wherein the safety node is configured to trigger the safe state by sending a safe state signal to the electronic device in response to identifying the failure signal.

9: The electronic control unit according to claim 7, wherein the safe state is a safe state of a load controlled by the electronic device.

10: The electronic control unit according to claim 1, wherein the electronic device comprises at least one of a switch and a driver.

11: The electronic control unit according to claim 1, wherein the safety node is configured to monitor a communication between the supervising controller and the application controller.

12: The electronic control unit according to claim 1, further comprising a transceiver configured to communicate with the supervising controller wherein the safety node is a part of the transceiver.

13: The electronic control unit according to claim 1, further comprising a power adapter, wherein the safety node is a part of the power adapter.

14: The electronic control unit according to claim 1, wherein the safety node is a part of the application controller, and wherein the safety node is a separated unit within the application controller.

15: A method for triggering a reset, the method comprising:
receiving input signals from a supervising controller at an electronic control unit;
monitoring the input signals by using a safety node of the electronic control unit; and
triggering a reset of an application controller of the electronic control unit in response to identifying a failure signal from the input signals.

16: The method according to claim 15, further comprising:
triggering a safe state in response to identifying a failure signal from the input signals.

17: A control system comprising:
a supervising controller configured to control an electronic control unit and
the electronic control unit comprising:
an electronic device;
an application controller configured to control the electronic device; and
a safety node configured to:
monitor input signals sent from the supervising controller to the electronic control unit;
identify a failure signal from the input signals; and
trigger a reset of the application controller in response to identifying the failure signal.

18: The control system according to claim 17, wherein the supervising controller is configured to monitor an operation of the application controller for identifying a failure of the application controller.

19: The control system according to claim 17, wherein the supervising controller is a central controller or a zone controller.

20. (canceled)
